(19) United States
(12) Patent Application Publication
(10) Pub. No.: US 2014/0254372 A1
(43) Pub. Date: Sep. 11, 2014

(54) SYSTEM, APPARATUS, PROCEDURE, AND COMPUTER PROGRAM PRODUCT FOR PROVISIONING A NETWORK

(71) Applicants: Kenneth M. Fisher, Aurora, IL (US); William J. Massey, Shorewood, IL (US)

(72) Inventors: Kenneth M. Fisher, Aurora, IL (US); William J. Massey, Shorewood, IL (US)

(73) Assignee: TELLABS OPERATIONS INC., Naperville, IL (US)

(21) Appl. No.: 13/791,444

(22) Filed: Mar. 8, 2013

(51) Int. Cl. H04L 12/70

(52) U.S. Cl. CPC H04L 47/10
USPC 370/235

(57) ABSTRACT

A procedure for provisioning a network, and a system, apparatus, and computer program that operate in accordance with the procedure. The procedure comprises performing a provisioning action to provision a traffic flow in a network. A graphical representation of a portion of the network is provided based on a result of the provisioning action. In one example aspect, the graphical representation comprises a plurality of representative elements representing one or more network components and one or more links between at least two of the plurality of representative elements. The network components comprise, for example, at least one of a network element, an optical channel, or a cross-connection, or the like.

### BACKGROUND

1. Field

Example aspects described herein relate generally to communication network design, and more particularly, to a system, apparatus, procedure, and computer program product for provisioning a network.

2. Description of Related Art

Presently, communication networks can be provisioned by using various techniques. According to one technique, a user can provision traffic by using a command-line interface to input textual commands, such as Transaction Language 1 (TL1) commands, into a management server or network element. However, this technique can be cumbersome and does not provide a user with a graphical representation of a network and/or provisioning information.

According to a second technique, a user can provision traffic by providing a command to a system to automatically (i.e., with minimal or no human interaction) provision traffic from a source network element to a destination network element. However, this technique does not permit the user to select and provision intermediate network elements, as the system automatically selects intermediate network elements. In addition, this technique does not provide the user with a graphical representation of the network and/or provisioning information.

According to a third technique, a user can provision traffic by interacting with a navigation tree user interface, which typically includes a static list of representative elements (e.g., icons and/or alphanumeric identification labels) representing network elements that are available in a network. To provision traffic from a source network element to a destination network element, the user sequentially selects and provisions the source network element, one or more intermediate network elements (if any), and the destination network element. However, the navigation tree is static and does not change in appearance based on the provisioning. Therefore, provisioning in this manner requires a user to manually keep track of the provisioning progress (e.g., how and which network elements have been provisioned thus far for a particular traffic flow). If the user loses track of the provisioning progress, the user must manually check each network element to see what has been provisioned.

### SUMMARY

Existing limitations associated with the foregoing, as well as other limitations, can be overcome by a procedure for provisioning a network, and by a system, apparatus, and computer program product that operate in accordance with the procedure.

In one example embodiment herein, the procedure includes performing a provisioning action to provision a traffic flow in a network. A graphical representation of a portion of the network is provided based on a result of the provisioning action.

The graphical representation includes, in one example, a plurality of representative elements representing one or more network components and one or more links between at least two of the plurality of representative elements. The graphical representation includes, in another example embodiment, a portion of the network through which the traffic flow has been provisioned by the performing of the provisioning action. In some example embodiments herein, the network components include at least one of a network element, an optical channel, or a cross-connection.

According to another example embodiment, the provisioning action includes at least one of a network element provisioning action, a shelf provisioning action, a module provisioning action, and/or a facility provisioning action.

Also in one example embodiment herein, the procedure further comprises executing a network discovery procedure after the performing of the provisioning action, and the providing the graphical representation includes providing the graphical representation based on a result of the network discovery procedure. The executing the network discovery procedure can include, in one example, obtaining network provisioning information relating to the result of the provisioning action from at least one of a management server or a database.

In a further example embodiment herein, the procedure further comprises presenting a representative element representing a network component and receiving a selection of the representative element. A menu of provisioning actions available in connection with the network component is provided, in response to the receiving of the selection. A selection of one provisioning action from the menu of provisioning actions is received, and the one provisioning action is performed.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, wherein:

FIG. 1 is a representation of an example system for provisioning a communication network, that is constructed and operated in accordance with at least one example aspect herein.

FIG. 2 is an architecture diagram of a processing system in accordance with an example embodiment described herein.

FIG. 3 is a flow diagram that illustrates an example procedure for provisioning a network, in accordance with an example embodiment described herein.

FIG. 4 is a screen shot showing a portion of a window including example network component representative elements and an example menu of provisioning actions, in accordance with an example embodiment herein.

FIG. 5 is a screen shot showing a portion of a window including an example graphical representation of a portion of a network, in accordance with an example embodiment herein.

FIG. 6 is a screen shot showing a portion of a window including an example graphical representation of a portion of a network, menu, and submenu, in accordance with an example embodiment herein.

FIG. 7 is a screen shot showing a portion of a window including an example refresh button, in accordance with an example embodiment herein.

FIG. 8 is a screen shot showing a portion of a window including a further example graphical representation of a portion of a network, in accordance with an example embodiment herein.

FIG. 9 is a screen shot showing a portion of a window including another example graphical representation of a portion of a network and menu, in accordance with an example embodiment herein.

FIG. 10 is a screen shot showing an example window for creating a cross-connection, in accordance with an example embodiment herein.

FIG. 11 is a screen shot showing a portion of a window including a further example graphical representation of a portion of a network, in accordance with an example embodiment herein.

FIG. 12 is a screen shot showing a portion of a window including another example graphical representation of a portion of a network, in accordance with an example embodiment herein.

FIG. 13 is a screen shot showing a portion of a window including an additional example graphical representation of a portion of a network, in accordance with an example embodiment herein.

FIG. 14 is a screen shot showing a portion of a window including yet another example graphical representation of a portion of a network, in accordance with an example embodiment herein.

FIG. 15 is a screen shot showing a portion of a window including a further example graphical representation of a portion of a network, in accordance with an example embodiment herein.

FIG. 16 shows an example validation window for performing one or more validation procedures, in accordance with an example embodiment herein.

### DETAILED DESCRIPTION

Presented herein is a novel and inventive procedure, and also a system, apparatus, and computer program product that operate in accordance with the procedure, for provisioning a network. In accordance with some aspects described herein, a user interface, such as a graphical user interface (GUI), is provided for provisioning complex networks including multiple degrees, multiple wavelengths, multiple types of services, and/or multiple drops. In one example aspect, the user interface may have the look and feel of, and/or be integrated with, a network validation user interface and/or a network troubleshooting user interface. In this way, a single user interface may be used to provision, validate, and/or troubleshoot a network, all while providing a holistic view of network elements and network configuration.

According to one example aspect herein, a procedure for provisioning a network is provided. In one example aspect herein, as described below, the procedure enables a user to provision a traffic flow through a network by sequentially selecting and performing a provisioning action for one or more network components, beginning with a source network component, then any intermediate network component(s), and finally a destination network component. In this way, as a result of performing the provisioning procedure, one or more paths (e.g., active path(s), protection path(s), and/or restoration path(s)) are established for the traffic flow from the source network component to the destination network component by way of any intermediate network component(s), if any. In one example embodiment, after each provisioning step, a graphical representation of the provisioned network is updated and presented to a user via a user interface.

Except as indicated otherwise herein, the term “provisioning” may be used herein to refer to configuring one or more network components to communicate and/or route a traffic flow throughout a network via one or more links and/or paths. The term “provisioning action” refers to an action of provisioning. Example types of provisioning actions include, without limitation, (1) a “View Microtopology” provisioning action, (2) network element provisioning actions, (3) shelf provisioning actions, (4) module provisioning actions, and (5) facility provisioning actions.

Example types of network element provisioning actions include, without limitation, (1) setting and/or viewing network element parameters (e.g., network element name, IP address, gateway, router, configuration type); (2) configuring a synchronous timing type and facilities; (3) configuring a network element clock (e.g., with the time of day); (4) configuring and/or viewing a network element state; (5) backing up and/or restoring a network element database; and (6) filtering an alarm profile and/or configuring how a network element reacts to an alarm.

Example types of shelf provisioning actions include, without limitation, (1) viewing properties of a shelf (e.g., serial number, part number, alarms); (2) configuring synchronization timing; and (3) creating modules for the shelf.

Example types of module provisioning actions include, without limitation, (1) viewing properties of a module (e.g., serial number, part number, alarms); (2) measuring optical power; (3) creating client ports; (4) creating payloads and/or mappings; (5) deleting modules; (6) changing a state of a module (e.g., in-service or out-of-service); (7) creating protection groups; (8) configuring protection parameters (e.g., configuring an active or working path, a protection path, manual protection, forced protection, lockout protection); (9) creating small form factor pluggable (SFP), 10 Gigabit small form factor pluggable (XFP), or C-form factor pluggable (CFP) removable optics; and (10) changing synchronization timing.

Example types of facility provisioning actions include, without limitation, (1) creating a port facility, (2) creating an Ethernet/Data facility and/or a Synchronous Optical Networking (SONET)/Synchronous Digital Hierarchy (SDH) facility, (3) provisioning a wavelength, (4) creating a cross-connection; (5) changing a facility type; (6) changing a facility parameter (e.g., laser shutdown, maintenance propagation, overhead settings, autonegotiation); (7) viewing alarms; (8) changing a state of a facility (e.g., in-service or out-of-service); (9) deleting a facility; (10) viewing protection status; and (11) configuring a protection switch.

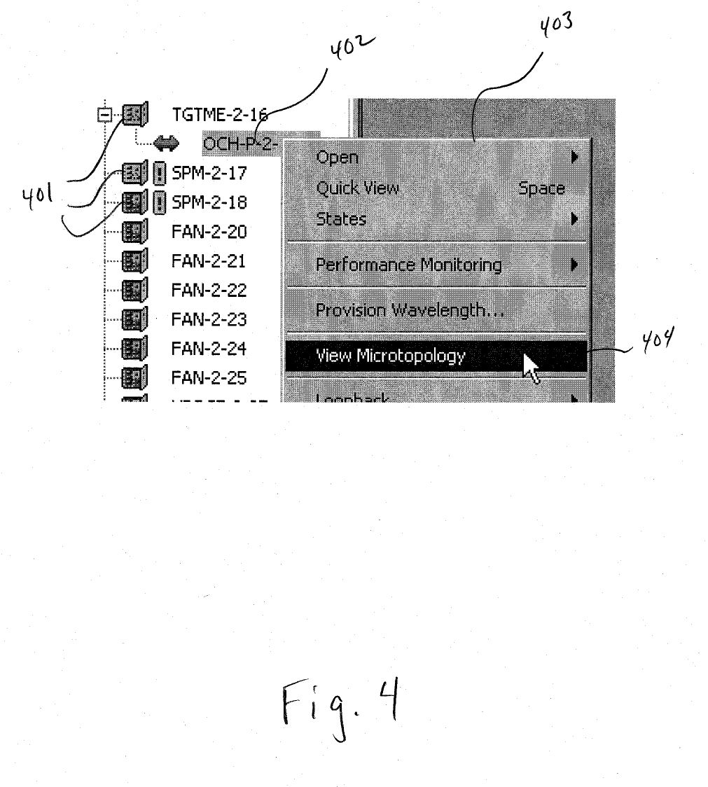

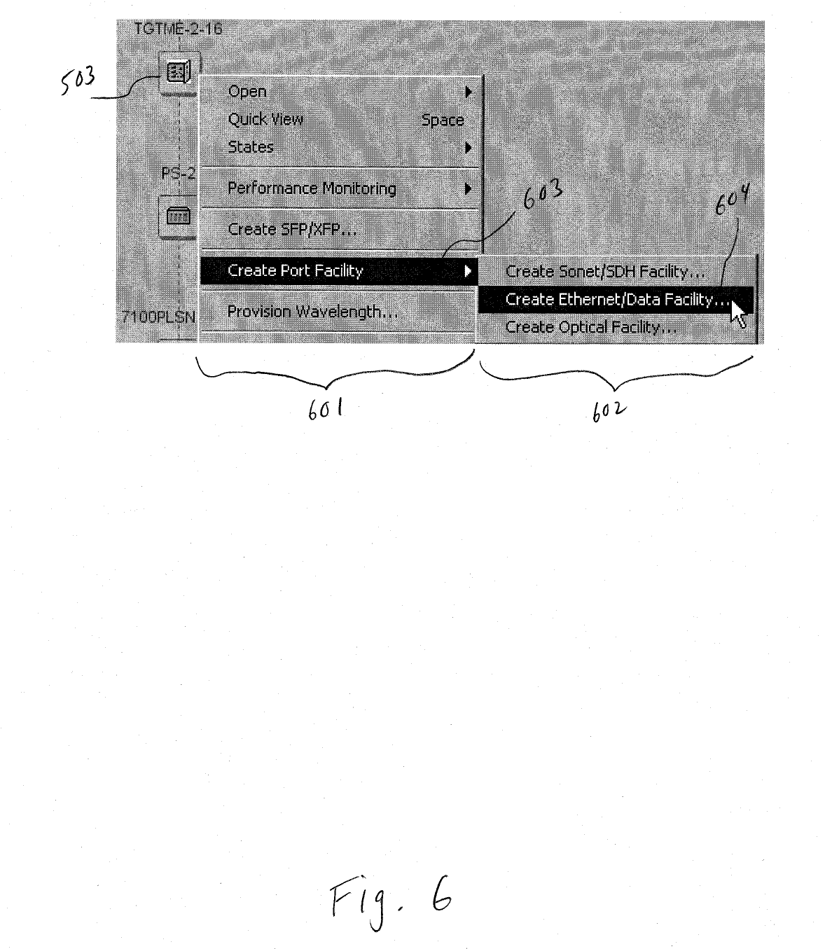

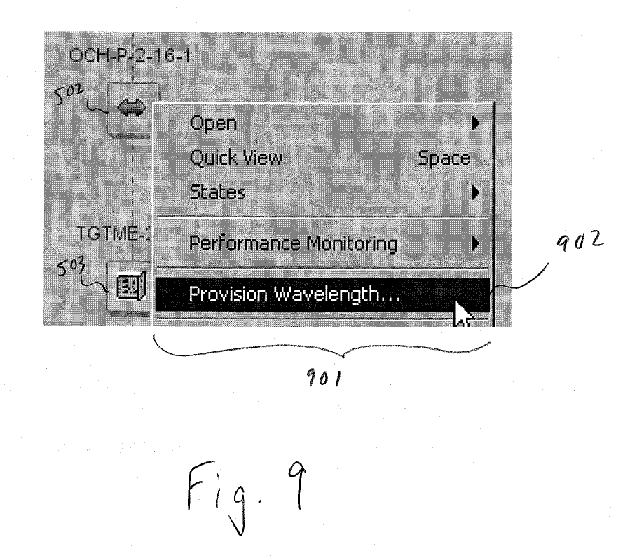

Specific examples of provisioning actions are also described below in connection with FIG. 4 (viewing a portion of a network (e.g., a topology or microtopology)), FIG. 6 (creating a port facility and/or an Ethernet/Data facility), and FIG. 9 (provisioning a wavelength).

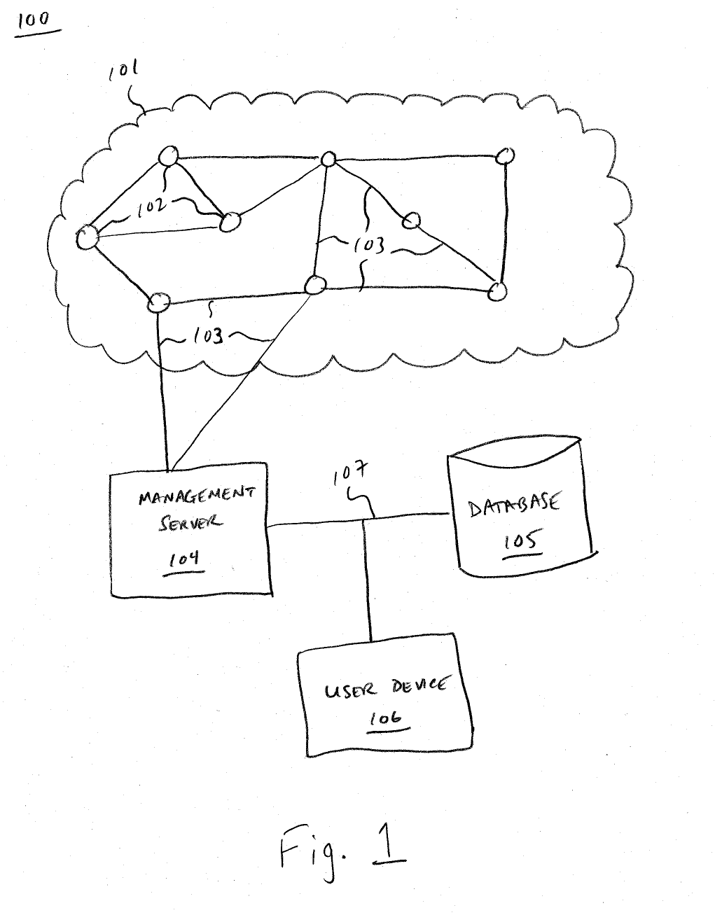

FIG. 1 is a representation of an example system 100 for provisioning a communication network 101 that is constructed and operated in accordance with at least one example embodiment described herein. In one example embodiment, the network 101 represents an optical transport network or a mesh network, although the network 101 can also represent other types of networks, such as, by example only, an IP network, a virtual private network, and/or the like.

The network 101 includes a plurality of nodes 102 (also referred to herein as “network elements”) each representing or including one or more network components, such as optical signal transmitters, receivers, and/or transceivers configured to transmit and/or receive network traffic signals, such as, by example only, optical signals and/or electrical signals. Although not shown in FIG. 1 for purposes of convenience, the network 101 and/or each node 102 may also include additional network components (which can be optical, electrical, and/or opto-electrical), such as, by example only, one or more multiplexers, routers, switches, wavelength selective switches, amplifiers, filters, processors, waveguides, reconfigurable optical add/drop multiplexers (ROADMs), opto-electrical converters, and/or the like. In one example, each node 102 may include one or more transceivers installed in a particular geographical location.

Each of the nodes 102 is communicatively coupled to one or more of the other nodes 102 via a path, which can include one or more links 103. The term “link”, as used herein, refers to a communicative coupling between two adjacent communication devices (e.g., nodes), by which the transceivers of the two devices can transmit and/or receive one or more signals to each other. In some example embodiments (e.g., in a dense wavelength-division multiplexed (DWDM) networking environment), each link 103 may represent multiple sub-links, i.e., multiple communicative couplings, between two adjacent nodes, with multiple corresponding transceivers at each node.

Example types of paths include an active path, a protection path, and a restoration path. An active path is a default path (i.e., the paths used in the absence of any associated network failure) by which the particular type of traffic is communicated between the corresponding nodes. A protection path is an alternate path between the nodes which can be quickly switched into (by, e.g., one or more optical and/or electrical switches included at a particular node, not shown in FIG. 1) in the event of a failure of the associated active path. A restoration path is an alternate path between the nodes which can be switched into use, but may require more time to be switched into use than a protection path, in the event of a failure of the associated active path. In one example embodiment, whether a node is capable of supporting a protection path or a restoration path depends on the type of switch(es) (fast switches or slow switches) included in the node. A protection path may be required for important traffic and/or traffic that requires fast switching. For example, for telephone traffic, if an active path experiences a failure, the network should quickly (e.g., in less than 50 milliseconds) switch to an alternate path (i.e., a protection path) because otherwise the telephone call may be dropped. In contrast, for Internet traffic, if an active path experiences a failure, it may be sufficient for the network to switch to an alternate path (i.e., a restoration path) more slowly because there is no risk of dropping a telephone call.

In one example embodiment, each link 103 is constructed of one or more optical fibers able to carry dense wavelength division multiplexed (DWDM) optical signals thereon, but this example should not be construed as limiting. In other example embodiments, each link 103 can represent a wireless communicative coupling or a wired communicative coupling, and the signals communicated through the network 101 can include optical signals, electrical signals, and/or electromagnetic signals.

Also included in the system 100 is a management server 104 that is communicatively coupled to one or more of the nodes 102 of the network 101 via the one or more links 103. The management server 104 is configured to receive one or more signals from, and/or to transmit one or more signals to, each of the nodes 102 via the one or more links 103. In particular, the management server 104 is configured to receive network information from the nodes 102 and to store the network information in a database 105. Except as indicated elsewhere herein, the term “network information” refers to information regarding a network, such as network 101. One example type of network information includes network component information, which can include information regarding particular network components that are available in a particular network. Example types of network component information include, without limitation, network component identifiers, network component representative elements, network component configuration information, network component capability information, and the like.

Another example type of network information includes provisioning information, which can include information regarding one or more network elements, network element configurations, links, and/or paths configured to enable a particular group or category of traffic to be communicated from a source to a destination in a network.

Network information can also include, without limitation, status information, alarm information, node configuration information, link configuration information, traffic demand information, capacity information, alarm location information, network policy information, and/or other types of information regarding a network. The management server 104 also is configured to control the operation of the nodes 102 of the network 101 by transmitting one or more control signals to the nodes 102. In one example embodiment, the management server 104 is configured to receive network information from the nodes 102, and to transmit one or more control signals to the nodes 102, by using a predetermined communication protocol (e.g., a command language).

The system 100 also includes a user device 106 that is communicatively coupled to the management server 104 and/or the database 105 via link 107. In one example embodiment, the user device 106 represents a personal computer, although the user device 106 can represent other types of user devices, such as, by example only, a client computer, a server computer, a laptop computer, a tablet computer, a mobile communication device, and/or the like. In some examples, the management server 104, the database 105, and the user device 106 are each configured to use a common communication protocol. The user device 106 includes a user interface (such as, e.g., the user interface 218 described below, which is a graphical user interface (GUI) in some example embodiments) that enables a user to interact with the user device 106 to control the operation of the nodes 102 by way of the management server 104, and/or to view the network information received from the nodes 102 via the management server 104 and stored in the database 105.

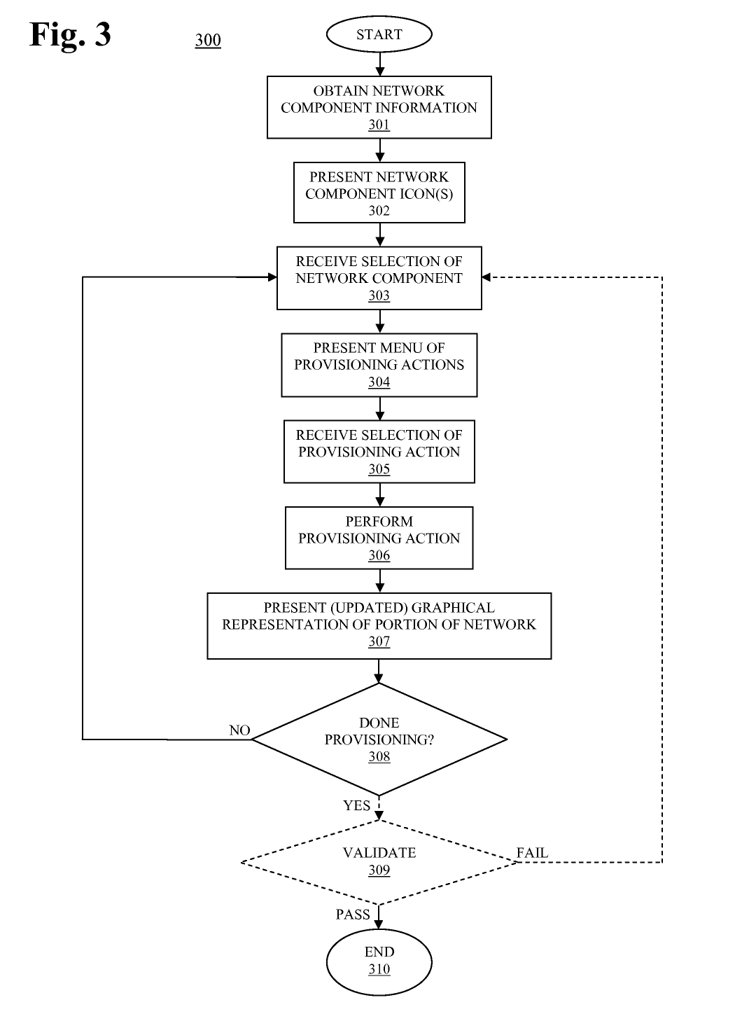

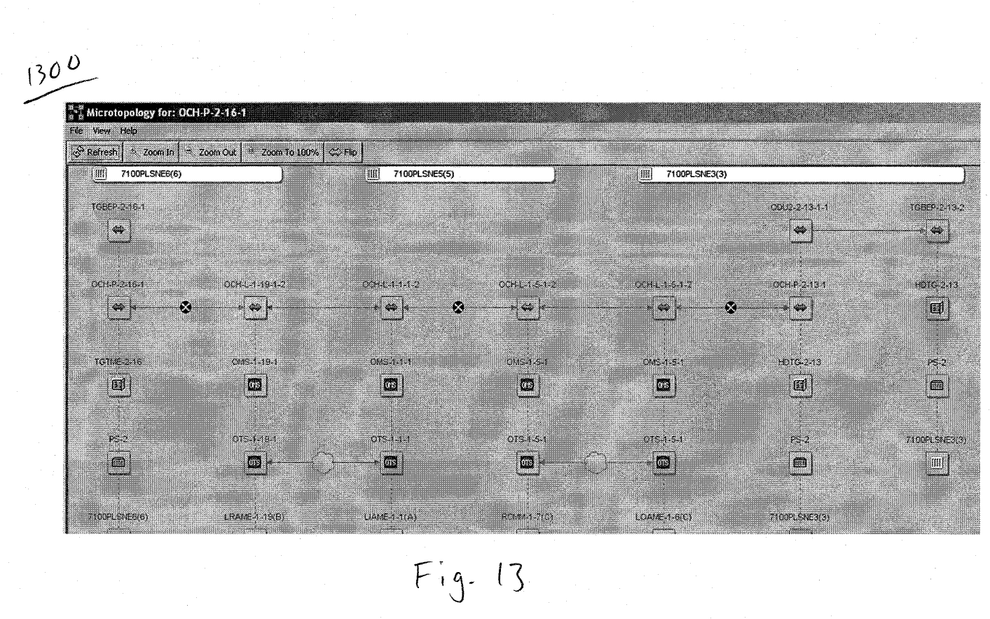

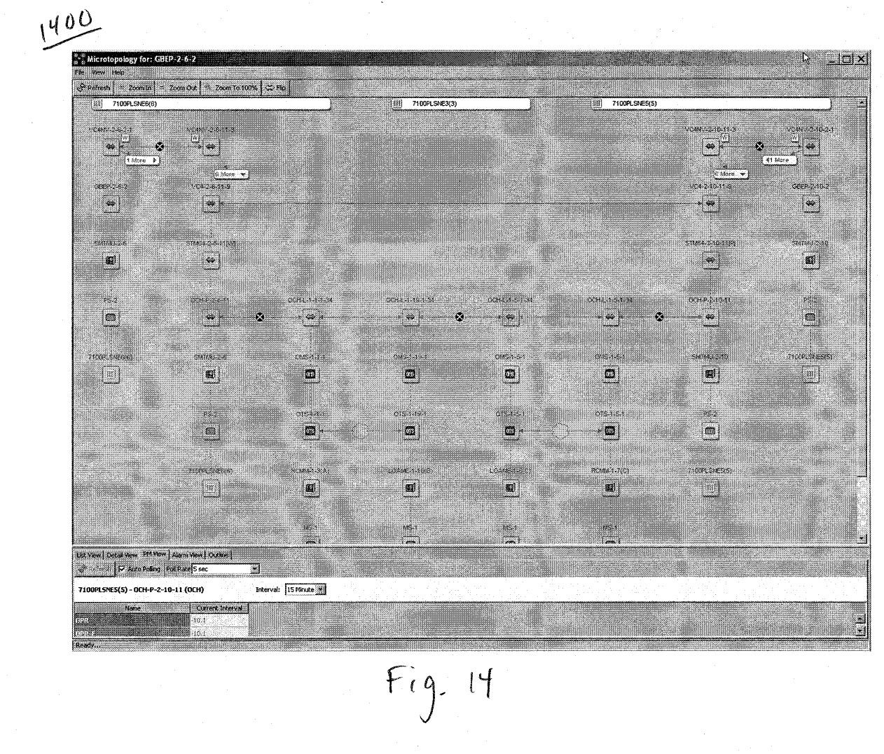

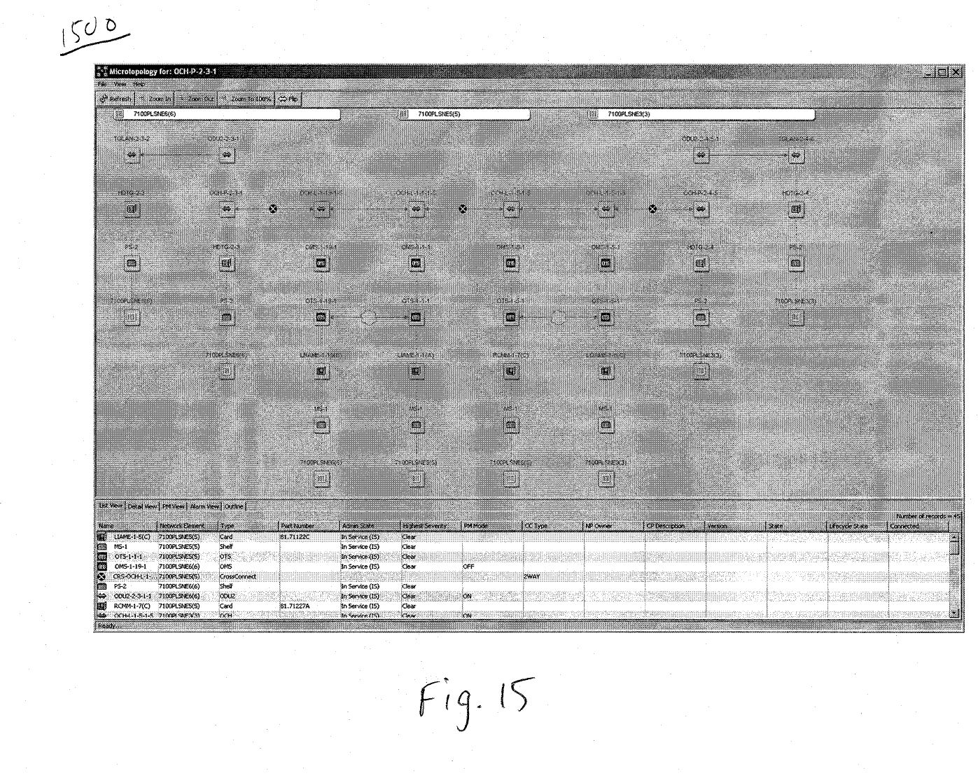

As will be described in further detail below in the context of the procedure 300 of FIG. 3 and the screen shots of FIGS. 4 through 15, in one example embodiment, a user can interact with the user device 106 to provision the network 101 and to view a graphical representation of the provisioned network 101, e.g., after each step of the provisioning is performed. In other words, after each provisioning step is performed, the graphical representation of the provisioned network is updated to reflect the results of the provisioning step and is presented to the user. In this way, the user is provided with a convenient and easy to understand view of the progress of the provisioning as it takes place. Thus, the example aspects described here are unlike traditional provisioning user interfaces, which typically include only a capability to perform provisioning (e.g., using a navigation tree interface that merely includes a static list of network elements available in a network), not to retrieve provisioning information (e.g., from a database and/or management server) and present a graphical representation of such provisioning information to a user in real-time or pseudo-real-time (e.g., after each provisioning step is performed).

The specific topology of the network 101 of FIG. 1 is provided for illustration purposes only, and should not be construed as limiting. For example, although FIG. 1 shows the management server 104 as being communicatively coupled to specific ones of the nodes 102 via the specific links 103, this is for illustrative purposes only. That is, the management server 104 can include other links and be communicatively coupled to more or less than the number of nodes 102 shown, and/or can be coupled to other ones of the nodes 102. According to some example embodiments, the management server 104 is communicatively coupled to all the nodes 102, whether by a single link 103 or by path(s) that includes a plurality of links 103.

Additionally, the particular number of components shown in the system 100 of FIG. 1 is provided for illustration purposes only, and should not be construed as limiting. That is, the system 100 may, in some example embodiments, include one or more of each of the components (e.g., nodes 102, links 103, management server 104, databases 105, and/or user devices 106) shown in FIG. 1. In one example embodiment, for redundancy, resiliency, and/or availability purposes, the system 100 can include an interconnected plurality of certain ones of the components (e.g., nodes 102, links 103, management server 104, database 105, and/or user device 106) shown in FIG. 1.

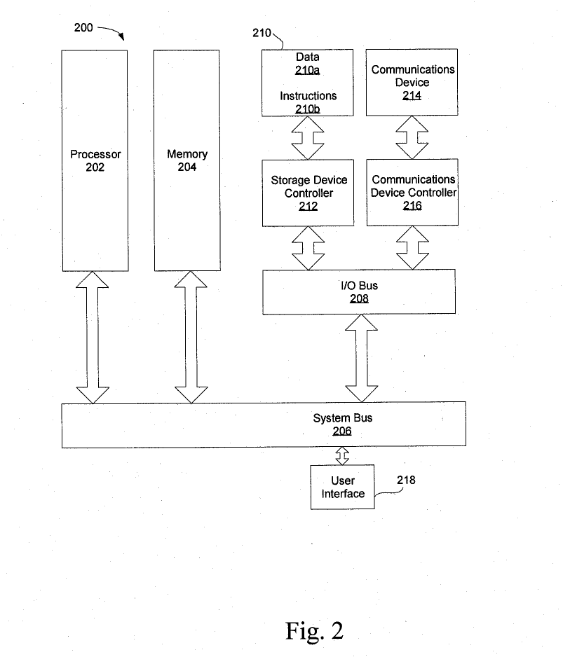

Reference is now made to FIG. 2, which is an architecture diagram of an example data processing system 200, which can be used according to various aspects herein. In one example embodiment, system 200 may further represent, and/or be included in, individual ones of the components of the system 100 of FIG. 1 (e.g., 102, 104, 105, 106). Data processing system 200 can be used to provision a network, such as the network 101 described above, according to one example. Data processing system 200 includes a processor 202 coupled to a memory 204 via system bus 206. Processor 202 is also coupled to external Input/Output (I/O) devices (not shown) via the system bus 206 and an I/O bus 208, and at least one input/output user interface 218. Processor 202 may be further coupled to a communications device 214 via a communications device controller 216 coupled to the I/O bus 208 and bus 206. Processor 202 uses the communications device 214 to communicate with other elements of a network, such as, for example, network nodes, and the device 214 may have one or more input and output ports. Processor 202 also may include an internal clock (not shown) to keep track of time, periodic time intervals, and the like.

A storage device 210 having a computer-readable medium is coupled to the processor 202 via a storage device controller 212 and the I/O bus 208 and the system bus 206. The storage device 210 is used by the processor 202 and controller 212 to store and read/write data 210a, as well as computer program instructions 210b used to implement the procedure(s) described herein and shown in the accompanying drawing(s) herein (and, in one example, to implement the functions represented in FIG. 3). The storage device 210 also can be used by the processor 202 and the controller 212 to store other types of data, such as network information (described above). In operation, processor 202 loads the program instructions 210b from the storage device 210 into the memory 204. Processor 202 then executes the loaded program instructions 210b to perform any of the example procedure(s) described herein, for operating the system 200.

Reference will now be made to FIG. 3 to describe an example procedure 300 for provisioning a network, in accordance with an example embodiment herein. In addition, reference will be made to FIGS. 4 through 15 to describe example screen shots of windows, menus, representative elements (e.g., icons and/or identification labels), and the like that may be used to perform one or more of the functions associated with the procedure 300. Except as indicated otherwise herein, the term “representative element” may be used herein to refer to a representation of an object, such as a network component, via a user interface, such as user interface 218. In some example embodiments herein, a representative element may include an icon and/or an identification label, such as an alphabetic, numeric, or alphanumeric identification label. The specific screenshots provided in FIGS. 4 through 15 and described herein are provided for illustration only, and should not be construed as limiting. In one example embodiment, each step of the procedure 300 can be implemented by one or more components of systems 100 and/or 200. In one non-limiting example, data processing system 200 can be included in user device 106 and can implement blocks 301 through 309 of the procedure 300. The following example implementation will be described in that context.

As will be described in further detail below, the procedure 300 enables a user to provision a traffic flow through a network by sequentially selecting and performing a provisioning action (described above) for one or more network components, beginning with a source network component, then any intermediate network component(s), and finally a destination network component. As a result of performing the provisioning procedure 300 one or more paths (e.g., active path(s), protection path(s), and/or restoration path(s)) are established for the traffic flow from the source network component to the destination network component by way of any intermediate network component(s), if any. In one example embodiment herein, after each provisioning step, a graphical representation of the provisioned network is updated and presented.

In order to enable a user to provision a traffic flow on a network, the user device 106, in conjunction with the management server 104, first executes a network discovery procedure to obtain (block 301) network information to be used for provisioning the traffic flow. The network information, according to one example, includes network component information (described above) and/or network provisioning information (which, as described below, may include, e.g., one or more results of one or more provisioning actions performed at previous iterations of block 306, and which may be used as described below in the context of block 307). In one example embodiment, the management server 104 periodically communicates with the network components (e.g., nodes 102) to obtain network component and/or network provisioning information, and stores and maintains an up-to-date collection of network component information and/or provisioning information (e.g., results of previously performed provisioning actions) in the database 105. At block 301, the user device 106 obtains the network component information (e.g., including a list of network components) and/or the provisioning information by requesting such information from the management server 104 and/or the database 105.

At block 302, based on the network component information obtained at block 301, the user device 106 presents, via a user interface (e.g., 218), a list of network component representative elements 401 representing one or more corresponding network components available in the network, as shown in FIG. 4. Example types of network components include, without limitation, (1) a network element (e.g., as identified by a network element terminal identifier (TID), such as 7100PLSNE6(6)), (2) a cross-connection, (3) an optical channel, (4) a 10 gigabit per second (Gbps) transponder (TGTME) that converts a 10 Gbps client interface to a DWDM compliant 10 Gbps line interface, (5) an optical channel (OCH), (6) a system processor module (SPM), (7) a fan, (8) a port shelf (PS), (9) a 10 Gbps Ethernet signal rate that matches the OC-192 framing standard (TGBEP), (10) a cross-connect, (11) an optical multiplexed section (OMS) including one or more OCHs, (12) an optical transport system (OTS) including one or more OCHs and an optical supervisory channel (OSC), (13) a long reach input amplifier module (LRAME), (14) an intermediate reach input amplifier module (LIAME), (15) a reconfigurable channel multiplexor module (RCMM), (16) an output amplifier module (LOAME), (17) an optical data unit (ODU), (18) a high density 10 Gbps module (HDTG), and/or other types of network components.

At block 303, the user begins provisioning a traffic flow by interacting with the user device 106 to select a network component (i.e., a source of the traffic flow) from among the list of network components presented at block 302. In one example embodiment, the selection is made by using a mouse or other user input device to perform a right-click operation while a cursor is hovering over a representative element (e.g., representative element 402) representing the network component to be selected.

At block 304, upon receiving the selection (block 303) of the network component, the user device 106 presents a menu of provisioning actions (e.g., menu 403) available to be performed in connection with the selected network component. Example types of provisioning actions available to be performed in connection with network components are described above.

At block 305, the user continues to provision the traffic flow by interacting with the user device 106 to select a provisioning action from the menu 403 of actions presented at block 304. In the example shown in FIG. 4, the user selects an action 404 designated as “View Microtopology”.

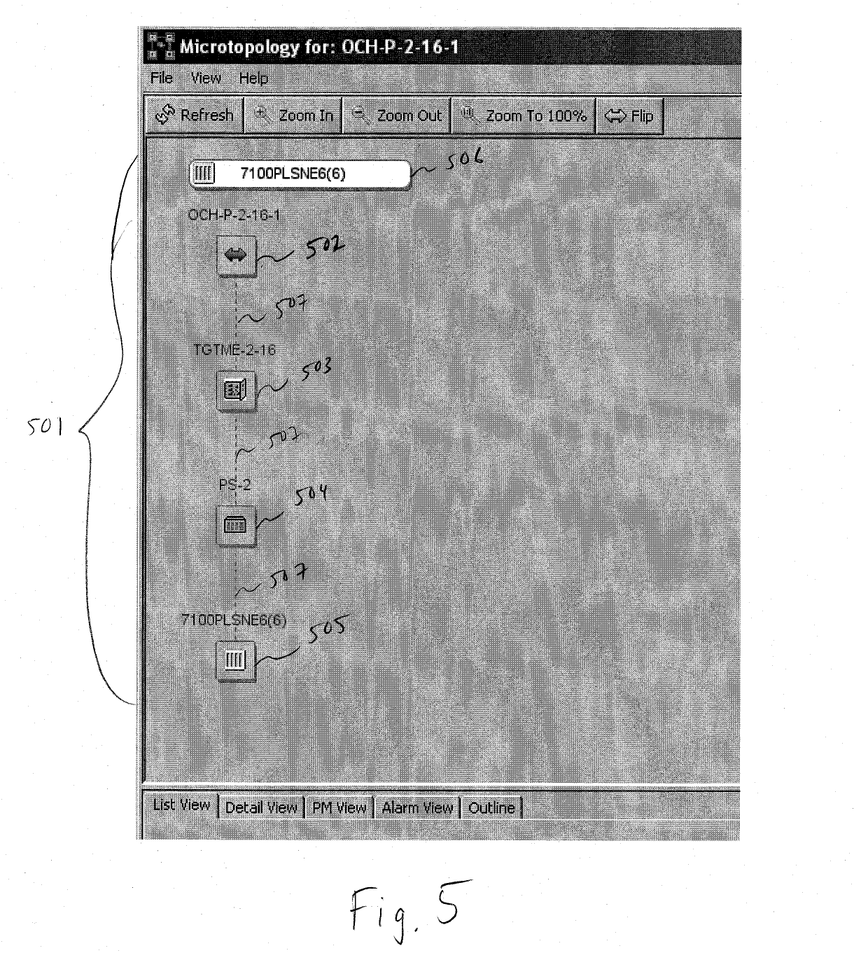

At block 306, the user device 106 performs the provisioning action that was selected at block 305. In one example embodiment, the user device 106 performs the provisioning action by providing, by way of the management server 104 and links 103, configuration instructions to one or more network components (e.g., one or more network components included in one or more of the nodes 102) to provision the traffic flow for those one or more network components. In the example of FIG. 4, upon receiving the selection of the “View Microtopology” action 404, as shown in FIG. 4, the user device 106 presents a graphical representation of the network component that was selected (block 303), as well as additional network components that are communicatively coupled to, and support, that selected component. An example of such a graphical representation 501 is shown in FIG. 5, where representative element 502 further represents the OCH network component represented by representative element 402 of FIG. 4. As shown in the example of FIG. 5, the network component 502 is included in a network element (i.e., a node) designated as “7100PLSNE6(6)” and represented by representative element 505. In addition, the network component 502 is communicatively coupled to network components 503 and 504 via links 507. Also, a representative element 506 is presented above network components 502 through 505 to indicate a network element (network element 7100PLSNE6(6), in this example) which the network components below the representative element 506 are associated with and/or included in.

At block 307, the user device 106 presents an updated graphical representation of a portion of the network, including particular network components that have been, or are available to be, used for provisioning the traffic flow. In one example embodiment, the user device 106 executes (at block 307 and/or any other instance where an updated graphical representation is to be presented) the network discovery procedure described above in connection with block 301 in order to obtain up-to-date network information and present, based on the up-to-date network information so obtained, an up-to-date graphical representation of the portion of the network. In one example embodiment, the network discovery procedure described above is executed after each provisioning action is performed (block 306), so as to provide an up-to-date representation of provisioning results.

In the example of FIG. 4, however, the action selected at block 305 (“View Microtopology”) does not result in any changes to the portion of the network, so the graphical representation is up-to-date and thus need not be updated at block 307.

At block 308, if provisioning is not complete (e.g., if the traffic flow has not yet been provisioned from a source network component to a destination network component) (“No” at block 308), then control passes back to block 303, where the procedure continues therefrom to perform a further iteration of the above-described functions to further provision the traffic flow.

For example, at (a second iteration of) block 303, the user continues to provision the traffic flow by interacting with the user device 106 to select a subsequent network component from among the list of network components presented at block 302. In the example shown in FIG. 6, the user selects a network component represented by representative element 503 (designated “TGTME-2-16”) by performing a right-click operation while a cursor is hovering over the representative element 503.

At (a second iteration of) block 304, upon receiving the selection (second iteration of block 303) of the network component 503, the user device 106 presents a menu, such as menu 601, of provisioning actions available to be performed in connection with the selected network component. In one example embodiment, the menu 601 also includes submenus, such as submenu 602, which include further provisioning actions available for the user to select by interacting with the user device 106.

At (a second iteration of) block 305, the user continues to provision the traffic flow by interacting with the user device 106 to select an action from the menu 601 and submenu 602 of actions presented at (the second iteration of) block 304. For example, as shown in FIG. 6, the user selects an action 603 designated “Create Port Facility” from menu 601 and then selects an action 604 designated “Create Ethernet/Data Facility” from submenu 602. Other example types of actions available to be performed in connection with various network components are described above in connection with block 304.

At (a second iteration of) block 306, the user device 106 performs the action that was selected at (the second iteration of) block 305. For example, upon receiving the selection of the “Create Ethernet/Data Facility” action 604, as shown in FIG. 6, the user device 106 communicates with the management server 104 to identify in the network an Ethernet/Data facility that is communicatively coupled to, and supports, the TGTME-2-16 component 503 selected at (the second iteration of) block 303, and that is available to be used for the traffic flow currently being provisioned.

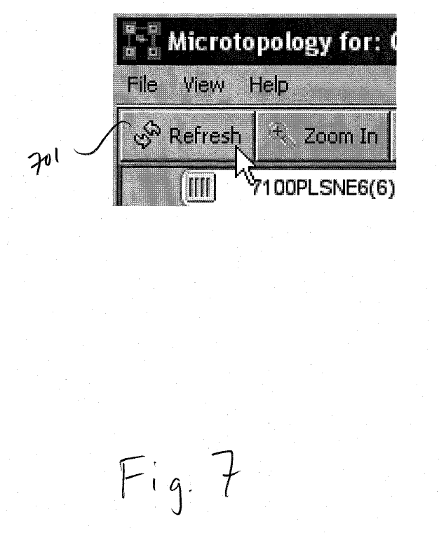

At (a second iteration of) block 307, the user device 106 presents an updated graphical representation of a portion of the network involved in the current provisioning procedure. For example, if the provisioning action performed at (the second iteration of) block 306 results in an additional network component being used to provision the traffic flow, then the graphical representation of the portion of the network is updated to include the additional network component. In one example embodiment, at (a second iteration of) block 307 the user device 106 executes the network discovery procedure described above in connection with block 301 in order to obtain up-to-date network information and present, based on the up-to-date network information so obtained, an up-to-date graphical representation of the portion of the network. According to one example embodiment, the user selects a refresh button, such as the refresh button 701 shown in FIG. 7, to cause the updated representation of the portion of the network to be presented. In another example embodiment, the updated representation of the portion of the network is presented automatically (at block 307) after the user device 106 performs the action at (the second iteration of) block 306.

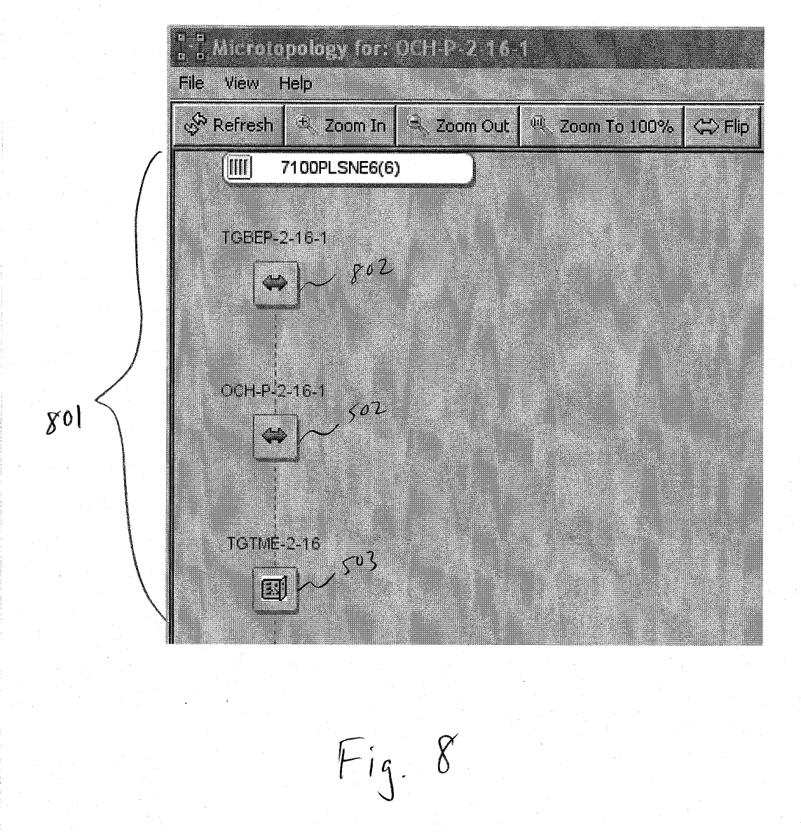

An example of an updated graphical representation 801 of the portion of the network is shown in FIG. 8. In one example embodiment, the portion of the network shown in the graphical representation 801 of FIG. 8 further represents the portion of the network shown in the graphical representation 501 of FIG. 5. However, for the sake of convenience, the graphical representation 801 of FIG. 8 does not include all of the components (502 through 507) shown in the graphical representation 501 of FIG. 5. For example, although the graphical representation 501 includes components 504 and 505, those components are not explicitly shown in the graphical representation 801. This is for convenience only, and it should be understood that, in a full view of the graphical representation 801, all of the components of the graphical representation 501 of FIG. 5 would be shown.

As shown in FIG. 8, the provisioning action performed at (the second iteration of) block 306 results in an additional network component 802 (designated “TGBEP-2-16-1”) being used to provision the traffic flow. Therefore, the updated graphical representation 801 of the portion of the network includes the additional network component 802. In this way, the graphical representation of the network appears to grow as the provisioning procedure 300 progresses and additional network components are used to provision the traffic flow.

At (a second iteration of) block 308, if provisioning is not complete (e.g., if the traffic flow has not yet been provisioned from a source network component to a destination network component) (“No” at block 308), then control passes back to block 303, where the procedure continues therefrom to perform a further iteration of the above-described functions to further provision the traffic flow.

For example, at (a third iteration of) block 303, the user continues to provision the traffic flow by interacting with the user device 106 to select a subsequent network component from among the list of network components presented at (the second iteration of) block 307. In the example shown in FIG. 9, the user selects a network component represented by representative element 502 (designated “OCH-P-2-16-1”) by performing a right-click operation while a cursor is hovering over the representative element 502.

At (a third iteration of) block 304, upon receiving the selection (third iteration of block 303) of the network component 502, the user device 106 presents a menu, such as menu 901, of provisioning actions available to be performed in connection with the selected network component 502.

At (a third iteration of) block 305, the user continues to provision the traffic flow by interacting with the user device 106 to select an action from the menu 901 of actions presented at (the third iteration of) block 304. For example, as shown in FIG. 9, the user selects an action 902 designated “Provision Wavelength” from menu 901.

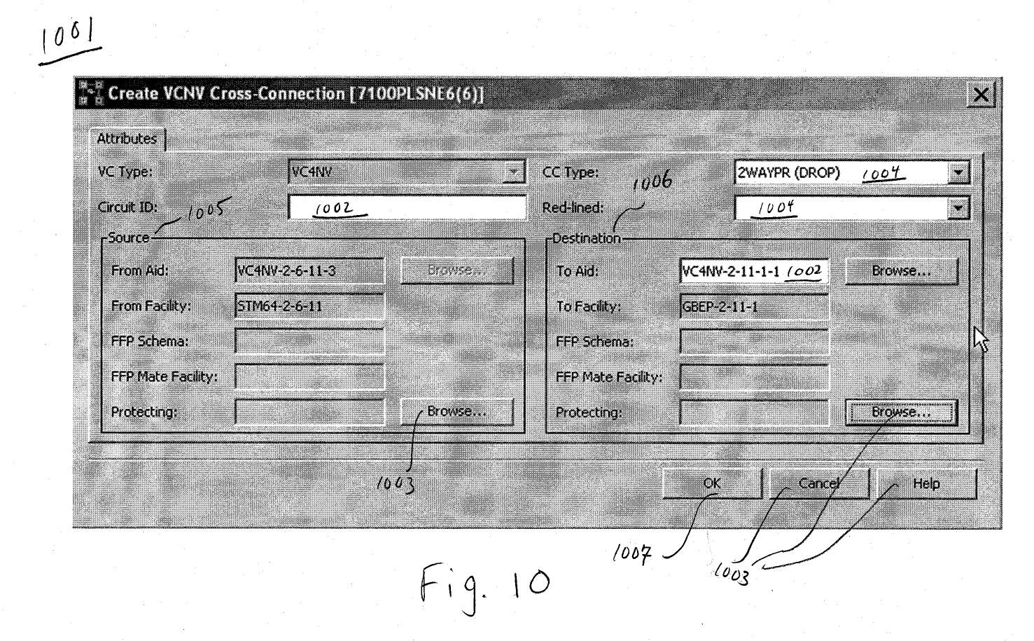

At (a third iteration of) block 306, the user device 106 performs the action that was selected at (the third iteration of) block 305. For example, upon receiving the selection of the “Provision Wavelength” action 902, as shown in FIG. 9, the user device 106 presents a provisioning window, such as the provisioning window 1001 shown in FIG. 10. In the example of FIG. 10, the provisioning window 1001 includes various input fields, such as text boxes 1002, buttons 1003, drop-down lists 1004, etc., that the user can interact with in a known manner to perform a provisioning action, in this example, creating a cross-connection. The provisioning window 1001 is used to configure and/or provide a cross-connection between two termination points (e.g., network components), such as a source network component and a destination network component, for example, to communicate synchronous transport signal (STS) payloads. The source network component can be selected and/or configured in a source subwindow 1005 of window 1001. The destination network component can be selected and/or configured in a destination subwindow 1006 of window 1001.

The provisioning window 1001 can be used to provision a unidirectional path, a bidirectional path, an unprotected active path, an active path with one corresponding protection path, and/or an active path with multiple corresponding protection paths. For example, to provision a bidirectional active path having no corresponding protection path, the provisioning window 1001 may be used to configure a cross-connection between two network components (i.e., a source network component and a destination network component). The source subwindow 1005 and the destination subwindow 1006 are interchangeable for a bidirectional path in that either of the two network components may be designated as the source network component (and configured in the source subwindow 1005) or the destination network component (and configured using the destination subwindow 1006). To provision an active path having one or more corresponding protection paths, the provisioning window 1001 may be used to configure cross-connections between multiple source network components and/or multiple destination network components. The provisioning window 1001 may also be used to configure one or more cross-connections between one source network component and two or more destination network components (e.g., between an unprotected network component, such as a client interface, and a protected network component).

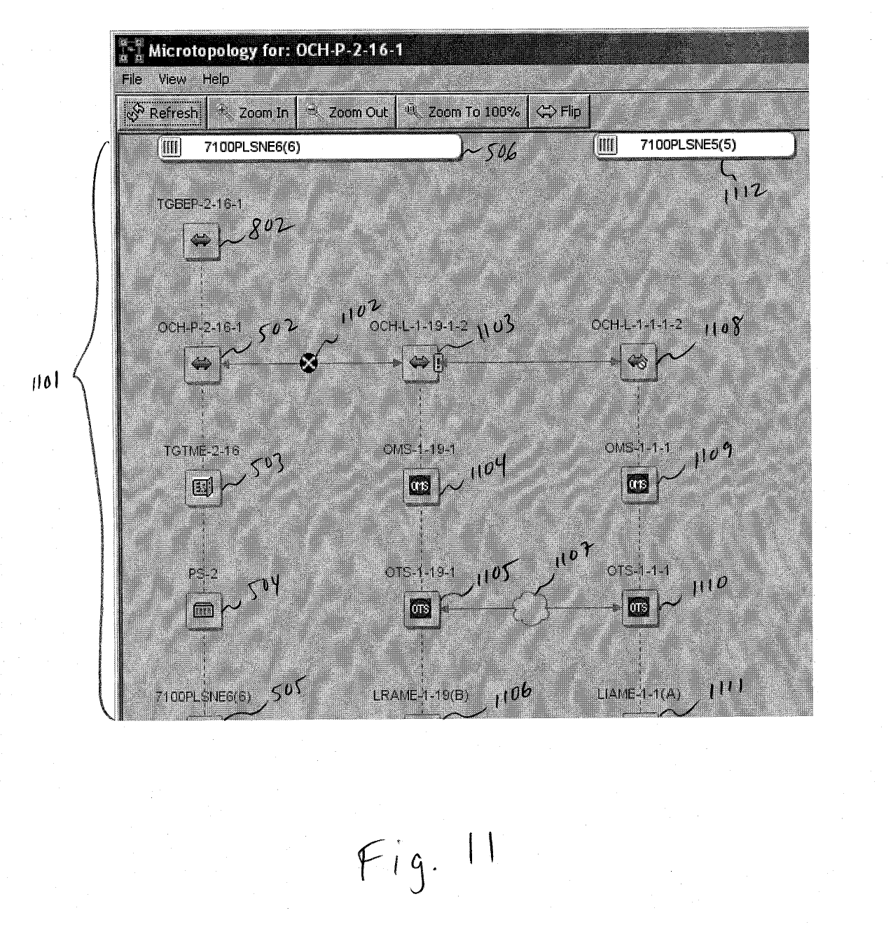

Referring back to FIG. 11 in conjunction with FIG. 10, after the user selects the “OK” button 1007, the user device 106 communicates with the management server 104 to configure in the network a cross-connection to be used for the traffic flow currently being provisioned. In one example embodiment, the user device 106 provides configuration instructions to one or more network components (e.g., one or more network components included in one or more of the nodes 102) by way of the management server 104 and links 103, to configure the cross-connection to accommodate the traffic flow.

At (a third iteration of) block 307, the user device 106 presents an updated graphical representation of a portion of the network involved in the current provisioning procedure. For example, if the provisioning action performed at (the third iteration of) block 307 results in an additional network component being used to provision the traffic flow, then the graphical representation of the portion of the network is updated to include the additional network component. As described above in connection with (the second iteration of) block 307, the updated representation of the portion of the network may be presented automatically after the user device 106 performs the action at (the second iteration of) block 306, or in response to the user selecting a refresh button (e.g., 701).

An example of an updated graphical representation 1101 of the portion of the network is shown in FIG. 11. In one example embodiment, the portion of the network shown in the graphical representation 1101 of FIG. 11 further represents the portion of the network shown in the graphical representations 501 and 801 of FIGS. 5 and 8, respectively.

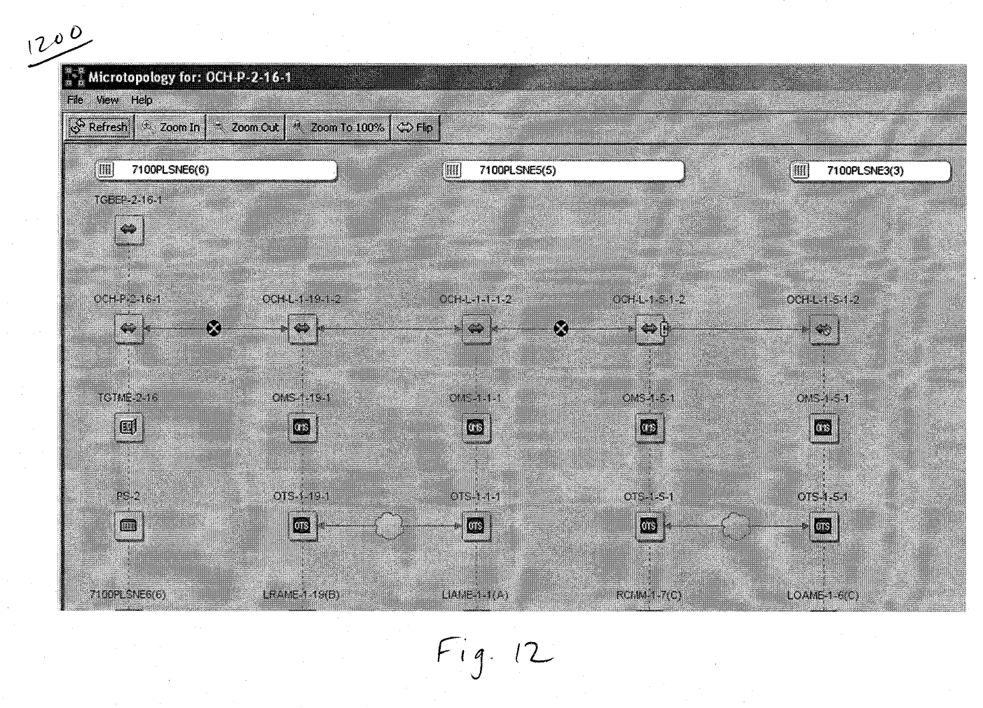

As shown in FIG. 11, the provisioning action performed at (the third iteration of) block 306 results in additional network components 1102 through 1112 being used to provision the traffic flow. The updated graphical representation 1101 of the portion of the network includes the additional network components 1102 through 1112. In this way, the graphical representation of the network becomes larger as the provisioning procedure 300 progresses and additional network components are used in provisioning the traffic flow. For example, graphical representations 1200, 1300, 1400, and 1500 are illustrated in FIGS. 12, 13, 14, and 15, respectively, and show progressively larger portions of the network that may result from additional iterations of the functions associated with blocks 303 through 308 of the procedure 300.

In addition, as shown in FIG. 11, the representative element 506 is positioned above network components 502 through 505, 802, and 1102 through 1106 to indicate that those network components are associated with and/or included in the network element (network element 7100PLSNE6(6), in this example) that corresponds to the representative element 506. Similarly, the representative element 1112 is positioned above network components 1108 through 1111 to indicate that those network components are associated with and/or included in the network element (network element 7100PLSNE6(6), in this example) that corresponds to representative element 1112.

In some example embodiments, if provisioning is complete (e.g., if the traffic flow has been provisioned from a source network component to a destination network component) (“Yes” at block 308), then the procedure 300 ends at block 310.

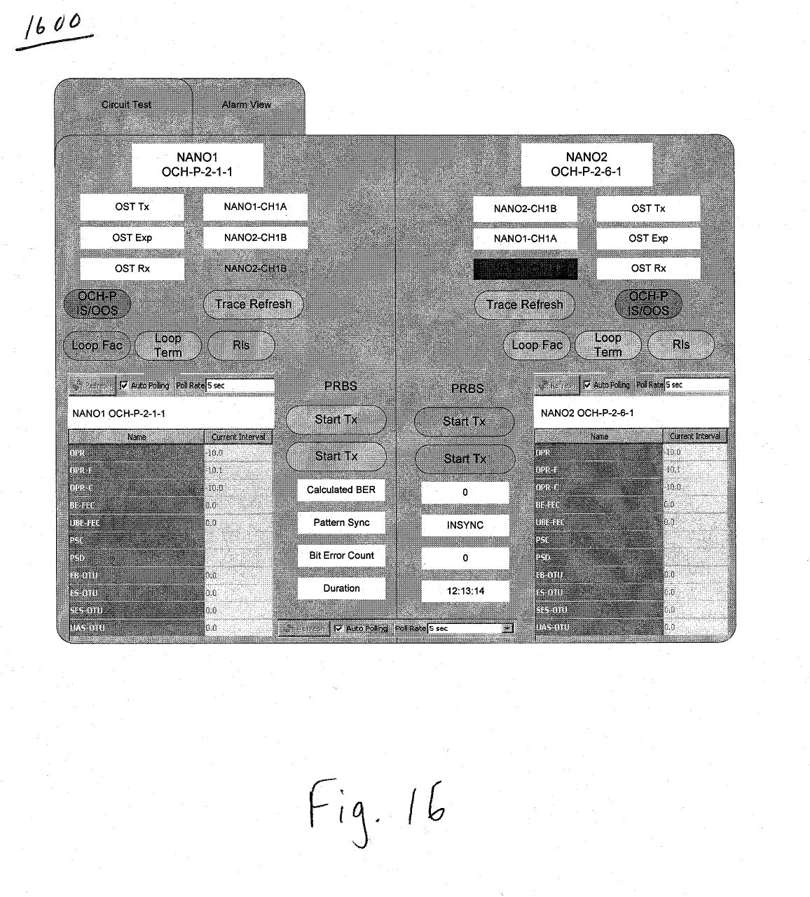

In other example embodiments, the procedure 300 can further include the function(s) associated with optional block 309. At block 309, the user can interact with the user device 106 to configure and execute one or more validation procedures (e.g., network validation procedures, circuit validation procedures, and/or the like) for the traffic flow that has been provisioned (at blocks 301 through 308) using the graphical representation of the portion of the network. In one example embodiment, the user can configure and execute one or more validation procedures by interacting in a known manner with a validation window, such as the validation window 1600 shown in FIG. 16, for performing one or more validation procedures. The validation window 1600 can be a standalone window, or can be included as a subwindow (e.g., arranged in a lower portion of a larger window) in a window that also includes a graphical representation of the portion of the network, such as, for example, graphical representation 501, 801, 1101, 1200, 1300, 1400, and/or 1500 described above. In another example embodiment, the user can launch a validation window (e.g., 1600) by performing a right-click operation while a cursor is hovering over a representative element of a network component (e.g., representative elements 401, 402, 502-506, 802, 1102-1112).

In one example embodiment, after the user has configured and initiated a validation procedure via the validation window 1600, the user device 106 obtains, from at least one of network components (e.g., network components included in one or more of the nodes 102), the management server 104, and/or the database 105, network information (described above) relating to the traffic flow that has been provisioned (at blocks 301 through 308). The user device 106 then executes the validation procedure based on the obtained network information.

Example types of circuit validation procedures include, without limitation, (1) measuring optical power, (2) validating transmit and receive circuit trace overhead, (3) retrieving performance monitoring data, (4) enabling and/or disabling facility loopbacks, (5) performing a circuit test, such as a pseudo-random bit sequence (PRBS) test, (6) using test instruments (e.g., externally connected to a network) to generate test signals, and/or the like.

If the circuit validation procedure executed at block 309 is successful (“PASS” at block 309) (e.g., an optical power level is measured as sufficient, where optical power is being validated), then the procedure 300 ends at block 310. On the other hand, if the circuit validation procedure executed at block 309 is unsuccessful in at least one respect or another (“FAIL” at block 309) (e.g., an optical power level is measured as insufficient), then control passes back to block 303, where the procedure 300 continues therefrom to perform a further iteration of the above-described functions to further provision the traffic flow, to correct any failures that may be apparent from the validation procedure results.

As can be appreciated in view of the above, the example aspects herein provide a procedure, as well as an apparatus, system, and computer program that operate in accordance with the procedure to provision a network. In accordance with some aspects described herein, a user device is provided having a user interface for provisioning complex networks including multiple degrees, multiple wavelengths, multiple types of services, and/or multiple drops. For example, the user interface may have the look and feel of, and/or be integrated with, a network validation user interface and/or a network troubleshooting user interface. In this way, a single user interface may be used to provision, validate, and/or troubleshoot a network, all while providing a holistic view of network elements and network configuration.

In addition, the user can interact with the user interface to provision the network and to view a graphical representation of the provisioned network, e.g., after each step of the provisioning is performed. In other words, after each provisioning step is performed, the graphical representation of the provisioned network is updated to reflect the results of the provisioning step and is presented to the user. In this way, the user is provided with a convenient and easy to understand view of the progress of the provisioning as it takes place. Thus, the example aspects described here are unlike traditional provisioning user interfaces, which typically include only a capability to perform provisioning (e.g., using a navigation tree interface that merely includes a static list of network elements available in a network), and which do not have a capability to also retrieve provisioning information (e.g., from a database and/or management server) and present a graphical representation of such provisioning information to a user in real-time (e.g., after each provisioning step is performed).

It should be noted that the network configurations represented in FIGS. 1, 5, 6, 8, 9, and 11 through 15 are merely illustrative in nature, and should not be construed as being limiting to the scope of the invention. Also, in other embodiments, the networks may have other configurations than those shown in FIGS. 1, 5, 6, 8, 9, and 11 through 15.

The devices and/or servers described herein may be, in one non-limiting example, a computer or farm of computers that facilitate the transmission, storage, and reception of information and other data between different points. From a hardware standpoint, in one example a server computer will typically include one or more components, such as one or more microprocessors (also referred to as “controllers”) (not shown), for performing the arithmetic and/or logical operations required for program execution. Also in one example, a server computer will also typically include disk storage media (also referred to as a “memory”), such as one or more disk drives for program and data storage, and a random access memory, for temporary data and program instruction storage. From a software standpoint, in one example a server computer also contains server software resident on the disk storage media, which, when executed, directs the server computer in performing its data transmission and reception functions. As is well known in the art, server computers are offered by a variety of hardware vendors, can run different operating systems, and can contain different types of server software, each type devoted to a different function, such as handling and managing data from a particular source, or transforming data from one format into another format.

In the foregoing description, example aspects of the invention are described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of example aspects described herein may be provided as a computer program product, or software, that may include an article of manufacture on a machine-accessible, computer-readable, and/or machine-readable medium (memory) having instructions. The instructions on the machine-accessible, computer-readable and/or machine-readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine-accessible medium”, “computer-readable medium”, “machine-readable medium”, or “memory” used herein shall include any medium that is capable of storing, encoding, or transmitting a sequence of instructions for execution by the machine and that cause the machine to perform any one of the procedures described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs. Indeed, the numbered parts of the above-identified procedures represented in the drawings may be representative of operations performed by one or more respective modules, wherein each module may include software, hardware, or a combination thereof.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures.

Although example aspects herein have been described in certain specific example embodiments, many additional modifications and variations would be apparent to those skilled in the art. It is therefore to be understood that the various example embodiments herein may be practiced otherwise than as specifically described. Thus, the present example embodiments, again, should be considered in all respects as illustrative and not restrictive.

What is claimed is:

1. A procedure for provisioning a network, the procedure comprising:
performing a provisioning action to provision a traffic flow in a network; and
providing a graphical representation of a portion of the network based on a result of the provisioning action.

2. The procedure of claim 1, wherein the graphical representation comprises (1) a plurality of representative elements representing one or more network components and (2) one or more links between at least two of the plurality of representative elements.

3. The procedure of claim 2, wherein the network components comprise at least one of a network element, an optical channel, or a cross-connection.

4. The procedure of claim 1, wherein the graphical representation comprises a portion of the network through which the traffic flow has been provisioned by the performing of the provisioning action.

5. The procedure of claim 1, wherein the provisioning action comprises at least one of a network element provisioning action, a shelf provisioning action, a module provisioning action, or a facility provisioning action.

6. The procedure of claim 1, wherein the procedure further comprises executing a network discovery procedure after the performing of the provisioning action, and wherein the providing the graphical representation comprises providing the graphical representation based on a result of the network discovery procedure.

7. The procedure of claim 6, wherein the executing the network discovery procedure comprises obtaining network provisioning information relating to the result of the provisioning action from at least one of a management server or a database.

8. The procedure of claim 1, wherein the procedure further comprises:
presenting a representative element representing a network component;
receiving a selection of the representative element;
providing a menu of provisioning actions available in connection with the network component, in response to the receiving of the selection;
receiving a selection of one provisioning action from the menu of provisioning actions; and
performing the one provisioning action.

9. A provisioning apparatus, comprising:
at least one processor arranged to:
perform a provisioning action to provision a traffic flow in a network; and
provide a graphical representation of a portion of the network based on a result of the provisioning action.

10. The apparatus of claim 9, wherein the graphical representation comprises (1) a plurality of representative elements representing one or more network components and (2) one or more links between at least two of the plurality of representative elements.

11. The apparatus of claim 10, wherein the network components comprise at least one of a network element, an optical channel, or a cross-connection.

12. The apparatus of claim 9, wherein the graphical representation comprises a portion of the network through which the traffic flow has been provisioned by the performing of the provisioning action.

13. The apparatus of claim 9, wherein the provisioning action comprises at least one of a network element provisioning action, a shelf provisioning action, a module provisioning action, or a facility provisioning action.

14. The apparatus of claim 9, wherein the at least one processor is further arranged to:
execute a network discovery procedure after the performing of the provisioning action; and
provide the graphical representation based on a result of the network discovery procedure.

15. The apparatus of claim 14, wherein the at least one processor is further arranged to execute the network discovery procedure by obtaining network provisioning information relating to the result of the provisioning action from at least one of a management server or a database.

16. The apparatus of claim 9, wherein the at least one processor is further arranged to:
present a representative element representing a network component;
receive a selection of the representative element;
provide a menu of provisioning actions available in connection with the network component, in response to the receiving of the selection;
receive a selection of one provisioning action from the menu of provisioning actions; and
perform the one provisioning action.

17. The apparatus of claim 9, further comprising:
a user interface, arranged to present the graphical representation of the portion of the network to a user.

18. The apparatus of claim 9, further comprising:
at least one communication interface, arranged to obtain network provisioning information relating to the result of the provisioning action from at least one of a management server or a database.

19. A non-transitory computer readable medium having stored thereon sequences of instructions, the sequences of instructions comprising instructions which, when executed by a computer system, cause the computer system to:
perform a provisioning action to provision a traffic flow in a network, and
provide a graphical representation of a portion of the network based on a result of the performing of the provisioning action.

20. The non-transitory computer readable medium of claim 19, wherein the graphical representation comprises (1) a plurality of representative elements representing one or more network components and (2) one or more links between at least two of the plurality of representative elements.
